(19) United States
(12) Patent Application Publication
(10) Pub. No.: US 2006/0084497 A1
(43) Pub. Date: Apr. 20, 2006

(54) Gaming device having one or more payline awards calculated as a function of the total wager

(76) Inventors: Daniel M. Marks, Washington, DC (US); Anthony M. Singer, Ringwood, NJ (US); Howard M. Marks, Scarsdale, NY (US)

Correspondence Address: BELL, BOYD & LLOYD LLC, P. O. BOX 1135, CHICAGO, IL, 60690-1135, US

(21) Appl. No.: 11/253,217

(22) Filed: Oct. 18, 2005

Related U.S. Application Data
(60) Provisional application No. 60/619,675, filed on Oct. 18, 2004.
(60) Provisional application No. 60/705,374, filed on Aug. 4, 2005.

(51) Int. Cl. A63F 13/00

(52) U.S. Cl. 463/20

(57) ABSTRACT

A gaming device which includes a variety of methods to calculate one or more line pay awards as a function of the total amount wagered upon the game. In one embodiment, the gaming device multiplies the award for the most valuable symbol combination appearing on any payline by the total amount wagered upon the game.

### PRIORITY CLAIM

This application is a non-provisional patent application that claims priority to and the benefit of U.S. Provisional Patent Application Ser. No. 60/619,675 filed on Oct. 18, 2004, and U.S. Provisional Patent Application Ser. No. 60/705,374 filed on Aug. 8, 2005, the entire contents of which are incorporated herein by reference.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### FIELD OF INVENTION

In general, the present invention relates to methods of calculating line pay awards in a multi-payline slot machine game. More particularly, the present invention calculates one or more line pay awards as a function of the total wager.

### BACKGROUND OF THE INVENTION

Gaming device manufacturers strive to make wagering gaming devices that provide as much enjoyment, entertainment and excitement as possible for players. Providing interesting and exciting primary or base games and secondary or bonus games in which a player has an opportunity to win potentially large awards or credits is one way to enhance player enjoyment and excitement. Certain known gaming devices use devices such as reels or wheels to enhance the attraction of the gaming machines to players and also to enhance the player's game playing experience. These devices enable a player to see physical movements of a game, a portion of a game, or a functional game event or element which increases the player's enjoyment of the game.

In one slot gaming device, the gaming device includes a plurality of reels and one or more paylines. Such gaming devices include any suitable number of reels, such as three to five reels, which each display any suitable number of symbols per reel, such as three symbols per reel. In these gaming devices, the player initiates the spinning of the reels by making one or more wagers on one or more paylines. Such gaming devices may have one, three, five, nine, fifteen, twenty-five or any other suitable number of paylines which are horizontal, vertical, diagonal or any combination thereof. The player wagers on a player selected number or combination of paylines, such as one, two, three, five, ten or fifteen paylines and the reels are activated to spin.

After the reels spin to generate a plurality of symbols, the gaming device analyzes the generated symbols to determine if the gaming device has randomly generated a winning symbol or winning symbol combination on one or more of the wagered on paylines. A conventional line pay award is calculated by multiplying the award value for the winning symbol combination by the amount wagered upon the payline upon which the winning symbol combination appears. Such calculated awards are provided to the player.

New methods of playing slot machines, therefore, are required to provide players, casinos, and manufacturers with uniquely entertaining slot machine games, including new ways to calculate line pay awards.

### SUMMARY OF THE INVENTION

The present invention includes a variety of methods to calculate one or more line pay awards as a function of the total amount wagered upon the game.

In one embodiment, the appearance or generation of a trigger symbol in the third column of the symbol initiates a Total Bet Multiplier feature. In this embodiment, the gaming device multiplies the award for the most valuable winning symbol combination appearing on a payline by the total bet. It should be appreciated that this feature can be triggered in any suitable manner or based on any suitable event, such as an event based on one or more symbol combinations, an event based on the player's wager, a predetermined event, a randomly determined event, an event determined based on the player's status (such as determined through a player tracking system), or an event determined based on time.

In one embodiment, upon the appearance of a trigger symbol, the game determines the values of winning symbol combinations appearing on each payline, whether or not the player has wagered upon the payline, and then issues an award as follows:

(1) if only one winning symbol combination appears, the value is multiplied by the total bet to calculate the award issued to the player;

(2) if two or more winning symbol combinations appear with differing values, the highest value is multiplied by the total bet to calculate the award issued to the player;

(3) if two or more winning symbol combinations appear with the same highest value, only one value is multiplied by the total bet to calculate the award issued to the player; and

(4) if no winning symbol combinations appear, no award issues to the player.

In addition to initiating the Total Bet Multiplier feature, in one embodiment, the trigger symbol also acts as a wildcard symbol to help form winning symbol combinations. A winning symbol combination using a trigger symbol is treated the same as any other symbol combination for the purposes of the Total Bet Multiplier feature.

Other objects, features and advantages will be apparent from the following detailed disclosure, taken in conjunction with the accompanying sheets of drawings, wherein like numerals refer to like parts, elements, components, steps and processes.

### BRIEF DESCRIPTION OF THE DRAWINGS

FIG. 1 is a elevation view of one of the display devices of the gaming device illustrating a total bet multiplier value above the symbol matrix and a winning symbol combination on a payline.

FIG. 2 is a elevation view of one of the display devices of the gaming device illustrating a total bet multiplier value above the symbol matrix, a trigger symbol on the third reel, and a winning symbol combination on a payline.

FIG. 3 is a elevation view of one of the display devices of the gaming device illustrating a total bet multiplier value above the symbol matrix, a trigger symbol on the third reel, and a winning symbol combination using the trigger symbol as a wildcard to help form a winning symbol combination on a payline.

FIG. 4 is a elevation view of one of the display devices of the gaming device illustrating a total bet multiplier value above the symbol matrix, a trigger symbol on the third reel, and winning symbol combinations of differing values on two paylines.

FIG. 5 is a elevation view of one of the display devices of the gaming device illustrating a total bet multiplier value above the symbol matrix, a trigger symbol on the third reel, and winning symbol combinations of the same value on two paylines.

FIG. 6A is a front perspective view of one embodiment of the gaming device disclosed herein.

FIG. 6B is a front perspective view of another embodiment of the gaming device disclosed herein.

FIG. 7A is a schematic block diagram of one embodiment of an electronic configuration for one of the gaming devices disclosed herein.

FIG. 7B is a schematic block diagram of one embodiment of a network configuration for a plurality of gaming devices disclosed herein.

### DETAILED DESCRIPTION

In one embodiment, to play the Total Bet Multiplier embodiment, the player initializes credits, sets the wager, spins the reels, collects line pay awards, and, if a trigger symbol appears, also collects a Total Multiplier Bet award, as described in more detail below.

Referring now to the drawings, the player initializes credits by depositing money in the form of coins, gaming tokens or paper currency into a coin head 26 or bill acceptor 28. Coins and gaming tokens are collected in a reservoir (not shown) inside the gaming machine; paper currency is collected in the bill acceptor (not shown) inside the gaming machine.

If the coins, gaming tokens or paper currency are validated as authentic, the player accrues the appropriate number of playing credits on the credit meter or credit display 116. More credits may be initialized, if necessary, by additional deposits. Alternatively, any method of initializing credits may be used including debit cards, credit cards, smart cards, or other form of electronic funds transfer.

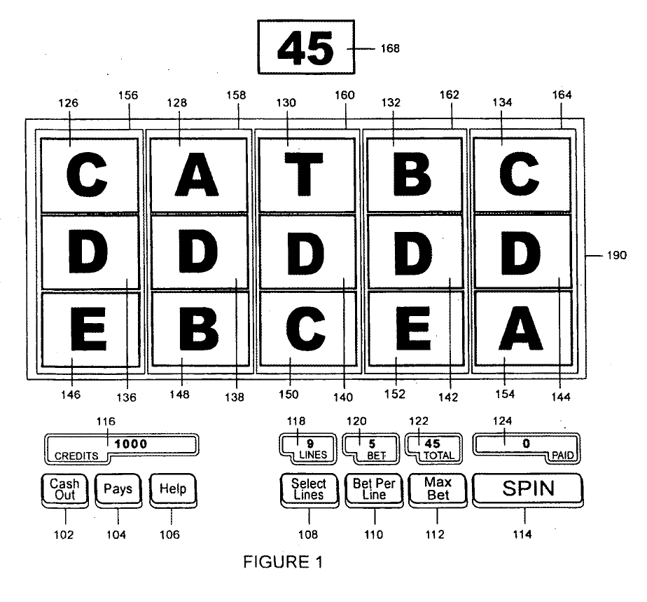

As seen in FIG. 1, the player sets the wager by selecting pay lines and setting the bet per pay line. The wager is calculated by multiplying the number of selected pay lines by the bet per pay line. For example, the player may wager five credits on each of nine pay lines for a total bet of forty-five credits. The total bet amount is displayed on the total bet meter/bet display 122.

To select pay lines, the player uses the Select Pay Lines button 108 and views the number of selected pay lines on the Select Pay Lines meter 118. Pay lines are selected in a predetermined order. For example, the first pay line selected is always pay line 1, second pay line selected is always pay line 2, etc. Alternatively, fewer or greater than nine pay lines may be used with any order of pay line activation.

To set the bet per pay line, the player uses the Bet Per Pay Line button 110 and views the amount bet per pay line on the Bet Per Pay Line meter 120. The same amount is wagered on each pay line. For example, up to five credits may be wagered on each pay line. Alternatively, wagers of any amount may be placed on a pay line, with the same or different amount wagered on each pay line.

In addition, the player may use the Bet Max button 112 to place the maximum bet per pay line on all pay lines. Alternatively, any predetermined wager may be assigned a button.

As illustrated in FIG. 1, in one embodiment, the Total Bet Multiplier value 168 appears above the symbol matrix 190. The Total Bet Multiplier value 168 equals the wager, as displayed in Total Bet meter 122. Alternatively, the Total Bet Multiplier value 168 may be determined by any function related to the wager. In particular, an alternative embodiment may increase the Total Bet Multiplier value 168 to a multiple of the wager at a predetermined wager level.

The player uses the Spin button 114 to cause a random rearrangement or generation of the symbols displayed in the symbol matrix 190. The symbol matrix 190 contains three symbol positions for each of the five slot reels 156, 158, 160, 162 and 164 for a total of fifteen symbol positions 126, 128, 130, 132, 134, 136, 138, 140, 142, 144, 146, 148, 150, 152, and 154. Alternatively, any suitable number of reels with any suitable number of symbol positions may be used.

The slot reels 156 to 164 spin and randomly stop. The symbols, however, are not instantly displayed in the symbol positions 126 to 154. Symbols appear one-at-a-time until all fifteen symbol positions 126 to 154 are revealed. Alternatively, any size symbol matrix may be used and any method may be used to rearrange symbols in the symbol matrix.

In one embodiment, line pay awards issue for winning symbol combinations formed by symbols appearing adjacently on a payline, starting from the leftmost position of a pay line. In FIG. 1, a winning D-D-D-D-D symbol combination 136 to 144 appears on a payline defined across the middle row 136 to 144 of the symbol matrix 190. The game calculates the value of the D-D-D-D-D symbol combination 136 to 144 by multiplying this symbol combination's award or value, as listed on a predetermined pay schedule or paytable (not shown), by the amount bet per pay line, as set by the Bet Per Pay Line button 110 and displayed on the Bet Per Pay Line meter 120.

In one embodiment, all line pays are defined on the pay schedule or paytable, with an award assigned to each listed line pay. In one of the Total Bet Multiplier embodiments, the pay schedule or paytable defines line pays as all combinations of three or more same symbols appearing adjacently on a payline, starting from left to right, and assigns a credit award for each such line pay. Alternatively, any number of line pays may be defined, with any award type and/or amount assigned to each line pay. The player may view the pay schedule by using the Pays button 104.

In one embodiment, the Total Bet Multiplier awards may issue when a trigger symbol (“TS”) appears in the symbol matrix 190. The award is calculated by multiplying the highest line pay award by the Total Bet Multiplier value 168.

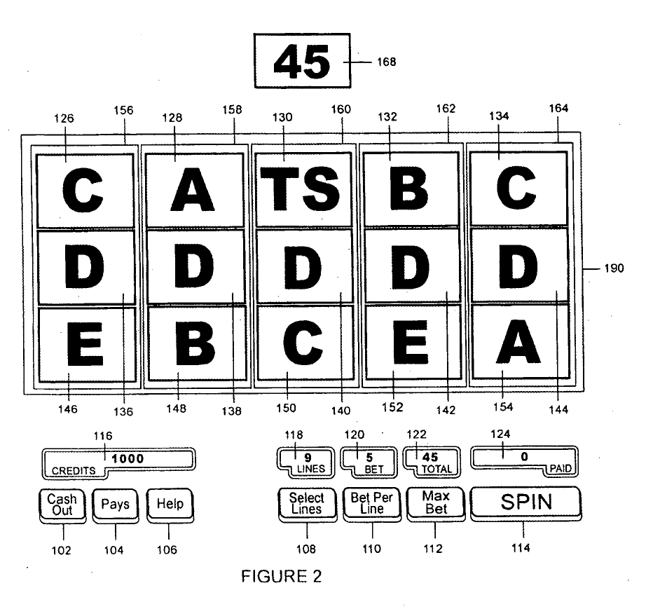

As seen in FIG. 2, a winning D-D-D-D-D symbol combination 136 to 144 appears on a payline defined across the middle row 136 to 144 of the symbol matrix 190 and a TS symbol appears in the top position 130 of the third reel 160 of symbol matrix 190. The TS symbol 130 triggers the Total Bet Multiplier award which the game calculates, as follows: first, the game determines that a winning D-D-D-D-D symbol combination appears in the symbol matrix 190; second, the game multiplies the value of the D-D-D-D-D symbol combination 136 to 144, as listed on a predetermined pay schedule (not shown), by the Total Bet Multiplier value 168; and third, the game issues the Total Bet Multiplier award to the player.

In one embodiment, the Total Bet Multiplier award issues whether or not the player has placed a wager upon the payline 136 to 144 with the D-D-D-D-D symbol combination 136 to 144. If the player wagered upon the payline 136 to 144, the game issues the line pay award and the Total Bet Multiplier award for the D-D-D-D-D symbol combination 136 to 144. In one embodiment, if the player did not wager upon the payline 136 to 144, the game only issues the Total Bet Multiplier award for the D-D-D-D-D symbol combination 136 to 144.

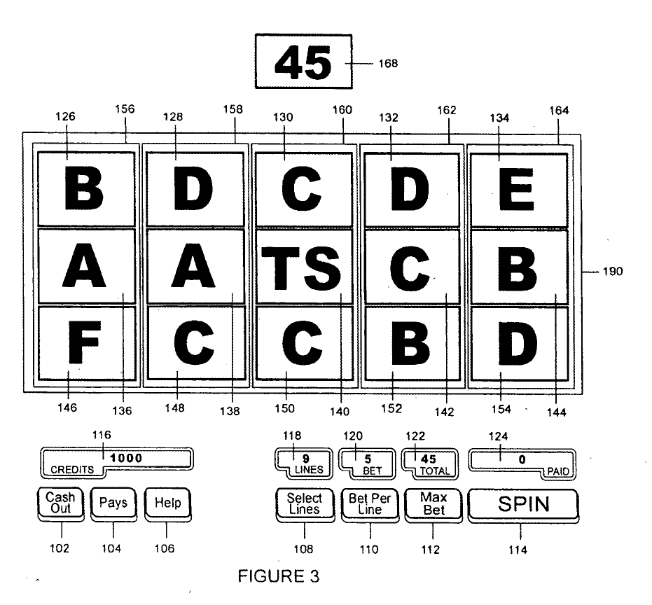

As illustrated in FIG. 3, a winning A-A-TS symbol combination 136 to 140 appears on a payline defined across the middle row 136 to 144 of the symbol matrix 190. The TS symbol 140 is a wildcard and acts as an A symbol to help form a winning A-A-A symbol combination. The TS symbol 140 triggers the Total Bet Multiplier award which the game calculates, as follows: first, the game treats the TS wildcard symbol 140 as an A symbol to help form a winning A-A-A symbol combination 136 to 140 in symbol matrix 190; second, the game multiplies the value of the A-A-A symbol combination 136 to 140, as listed on a predetermined pay schedule (not shown), by the Total Bet Multiplier value 168; and third, the game issues the Total Bet Multiplier award to the player.

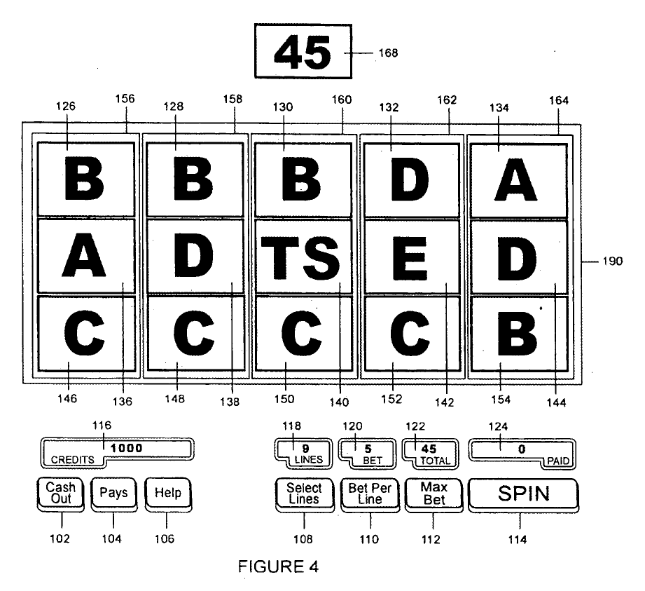

As illustrated in FIG. 4, a winning B-B-B symbol combination 126-130 appears on a payline defined across the top row 126 to 134 and another winning C-C-C-C symbol combination 146 to 152 appears on a payline defined across the bottom row 146 to 154 of the symbol matrix 190. The TS symbol appears in the middle position 140 of the third reel 160 of symbol matrix 190. The TS symbol 140 triggers the Total Bet Multiplier award which the game calculates, as follows: first, the game determines that the B-B-B 126 to 130 and C-C-C-C 146 to 152 winning symbol combinations appear in the symbol matrix 190; second, the game determines that the C-C-C-C symbol combination 146 to 152 has the highest award value; third, the game multiplies the value of the C-C-C-C symbol combination 146 to 152, as listed on a predetermined pay schedule (not shown), by the Total Bet Multiplier value 168; and fourth, the game issues the Total Bet Multiplier award to the player.

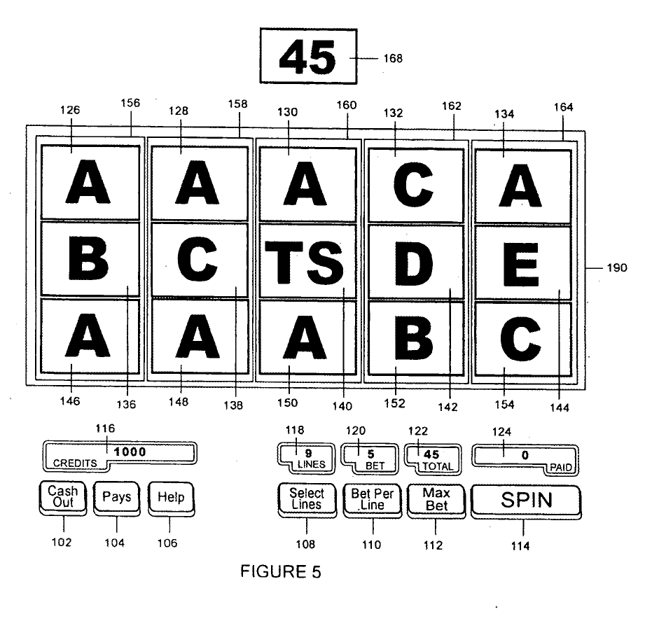

In FIG. 5, a winning A-A-A symbol combination 126 to 130 appears on a payline defined across the top row 126 to 134 and another winning A-A-A symbol combination 146 to 150 appears on a payline defined across the bottom row 146 to 154 of the symbol matrix 190. The TS symbol appears in the middle position 140 of the third reel 160 of symbol matrix 190. The TS symbol 140 triggers the Total Bet Multiplier award which the game calculates, as follows: first, the game determines that the A-A-A 126 to 130 and A-A-A 146 to 150 winning symbol combinations appear in the symbol matrix 190; second, the game determines that these two symbol combinations are both the highest value awards and of equal values; third, the game multiplies the value of only one A-A-A symbol combination 126 to 130, as listed on a predetermined pay schedule (not shown), by the Total Bet Multiplier value 168; and fourth, the game issues the Total Bet Multiplier award to the player.

Following issuance of line pay and Total Bet Multiplier awards, the cumulative credits are added to the player's balance of credits. As long as the player has credits on the credit meter 116, the player may continue to play the gaming machine or the player may also collect the balance of credits by pressing the Cash Out button 102. In addition, the player may press the Help button 106 to view the rules of the game.

In one example, the gaming device provides a 9 payline game wherein the player can bet or wager from 1 to 5 credits per payline. In this example, the player may place a total wager of 1 to 45 credits and thus the Total Bet Multiplier value may range from 1 to 45, depending on the amount of the player's wager. In another example, the gaming device provides a 25 payline game wherein the player can bet or wager from 1 to 5 credits per payline. In this example, the player may place a total wager of 1 to 125 credits and thus the Total Bet Multiplier value may range from 1 to 125, depending on the amount of the player's wager. In one such example, if the player wagers 2 credits on each of the 25 paylines, the Total Bet Multiplier value is 50. It should be appreciated that in these embodiments, the total award provided to the player is based on the total wagers placed on all of the paylines and not just the wager placed on the payline which the winning symbol combination was generated on.

In one alternative embodiment, the present invention may use a symbol matrix of any size, such as a symbol matrix with 4 rows and 6 columns. In different embodiments, the size of the symbol matrix is predetermined, randomly determined, determined based on the player's wager, determined based on the player's status (such as determined through a player tracking system), determined based on time or determined based on any other suitable method.

In another embodiment, the present invention may use any number of paylines, such as 10, 25, 30 or 50 paylines. In different embodiments, the number of paylines is predetermined, randomly determined, determined based on the player's wager, determined based on the player's status (such as determined through a player tracking system), determined based on time or determined based on any other suitable method.

In another embodiment, the present invention may be triggered by any suitable event, such as an event based on one or more symbol combinations, an event based on the player's wager, a predetermined event, a randomly determined event, an event determined based on the player's status (such as determined through a player tracking system), or an event determined based on time.

In another embodiment, the present invention may calculate any number of line pay awards as a function of the total wager, such as the most valuable and least valuable line pay awards.

In another embodiment, the present invention may calculate line pay awards using any subset of symbols as a function of the total wager, such as only calculating awards for symbol combinations using “cherry” or other “fruit” symbols.

In another embodiment, the present invention may calculate line pay awards appearing on a subset of paylines as a function of the total wager, such as only calculating awards on odd paylines.

In another embodiment, the present invention may calculate line pay awards by multiplying a line pay award (PA) by the total bet (TS) plus a factor that remains constant across all game play options, outcomes, and events (CF), or PA*(TS+CF).

In another embodiment, the present invention may calculate line pay awards by multiplying a line pay award (PA) by the total bet (TS) plus a factor that varies in response to some or all game play options, outcomes, or events (VF), or PA*(TS+VF). In different embodiments, the varying factor is randomly determined, determined based on the player's wager, determined based on the player's status (such as determined through a player tracking system), determined based on time or determined based on any other suitable method.

In another embodiment, the present invention may calculate some line pay awards differently than others, such as multiplying a first line pay award (PA1) by the total bet (TS), or PA1*TS, and multiplying a second line pay award (PA2) by the total bet (TS) plus a constant factor (CF), PA2*(TS+CF). In different embodiments, the manner in which pay awards are calculated is predetermined, randomly determined, determined based on the player's wager, determined based on the player's status (such as determined through a player tracking system), determined based on time or determined based on any other suitable method.

In another embodiment, the present invention may be used as an optional game feature, such as a feature that is purchased with a supplemental wager by the player.

In another embodiment, the present invention may be used as a bonus game feature, such as a feature to a free-spin bonus game.

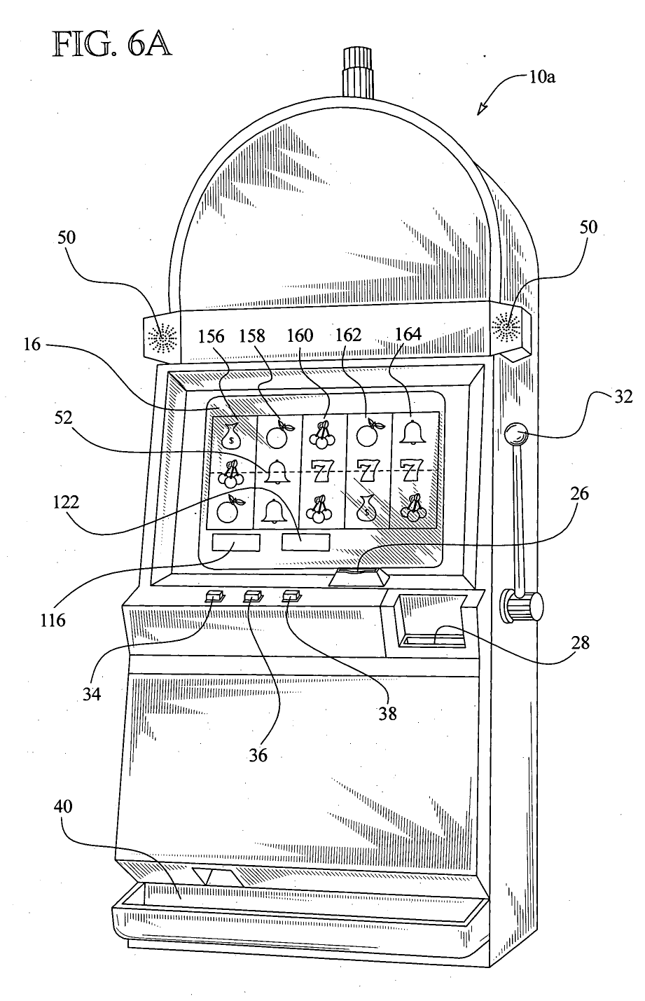

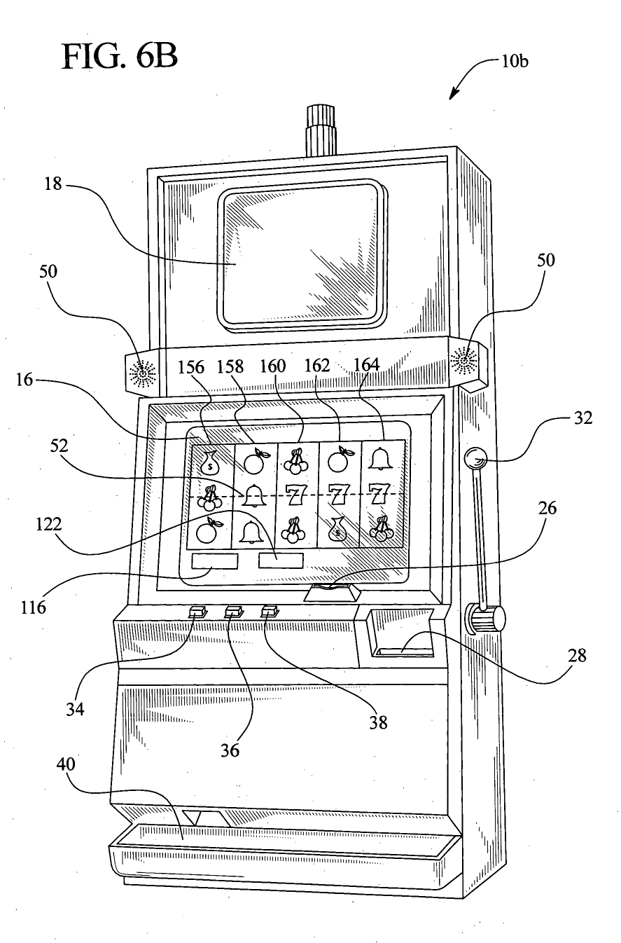

Two alternative embodiments of the gaming device are illustrated in FIGS. 6A and 6B as gaming device 10a and gaming device 10b, respectively. Gaming device 10a and/or gaming device 10b are generally referred to herein as gaming device 10.

In one embodiment, as illustrated in FIGS. 6A and 6B, gaming device 10 has a support structure, housing or cabinet which provides support for a plurality of displays, inputs, controls and other features of a conventional gaming machine. It is configured so that a player can operate it while standing or sitting. The gaming device may be positioned on a base or stand or can be configured as a pub-style table-top game (not shown) which a player can operate preferably while sitting. As illustrated by the different configurations shown in FIGS. 6A and 6B, the gaming device may have varying cabinet and display configurations.

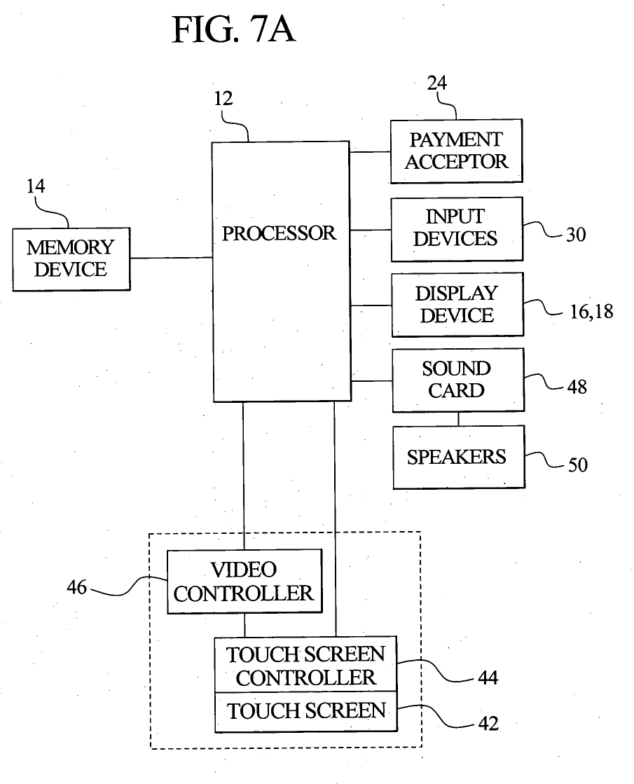

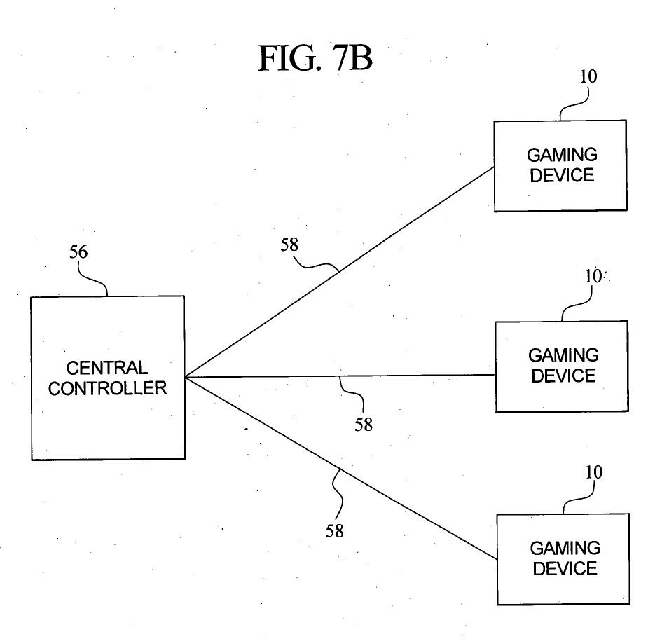

In one embodiment, as illustrated in FIG. 7A, the gaming device preferably includes at least one processor 12, such as a microprocessor, a microcontroller-based platform, a suitable integrated circuit or one or more application-specific integrated circuits (ASIC's). The processor is in communication with or operable to access or to exchange signals with at least one data storage or memory device 14. In one embodiment, the processor and the memory device reside within the cabinet of the gaming device. The memory device stores program code and instructions, executable by the processor, to control the gaming device. The memory device also stores other data such as image data, event data, player input data, random or pseudo-random number generators, pay-table data or information and applicable game rules that relate to the play of the gaming device. In one embodiment, the memory device includes random access memory (RAM), which can include non-volatile RAM (NVRAM), magnetic RAM (MRAM), ferroelectric RAM (FeRAM) and other forms as commonly understood in the art. In one embodiment, the memory device includes read only memory (ROM). In one embodiment, the memory device includes flash memory and/or EEPROM (electrically erasable programmable read only memory). Any other suitable magnetic, optical and/or semiconductor memory may operate in conjunction with the gaming device disclosed herein.

In one embodiment, part or all of the program code and/or operating data described above can be stored in a detachable or removable memory device, including, but not limited to, a suitable cartridge, disk, CD ROM, DVD or USB memory device. A player can use such a removable memory device in a desktop, a laptop personal computer, a personal digital assistant (PDA) or other computerized platform. The processor and memory device may be collectively referred to herein as a “computer” or “controller.”

In one embodiment, as discussed in more detail below, the gaming device randomly generates awards and/or other game outcomes based on probability data. That is, each award or other game outcome is associated with a probability and the gaming device generates the award or other game outcome to be provided to the player based on the associated probabilities. In this embodiment, since the gaming device generates outcomes randomly or based upon a probability calculation, there is no certainty that the gaming device will ever provide the player with any specific award or other game outcome. Such random determination could be provided through utilization of a random number generator (RNG) or other suitable randomization process.

In another embodiment, as discussed in more detail below, the gaming device employs a predetermined or finite set or pool of awards or other game outcomes. In this embodiment, as each award or other game outcome is provided to the player, the gaming device removes the provided award or other game outcome from the predetermined set or pool. Once removed from the set or pool, the specific provided award or other game outcome cannot be provided to the player again. This type of gaming device provides players with all of the available awards or other game outcomes over the course of the play cycle and guarantees the amount of actual wins and losses. In another embodiment, upon a player initiating game play at the gaming device, the gaming device enrolls in a bingo game. In this embodiment, a bingo server calls the bingo balls that result in a specific game outcome. The resultant game outcome is communicated to the individual gaming device to be provided to a player.

In one embodiment, as illustrated in FIG. 7A, the gaming device includes one or more display devices controlled by the processor. The display devices are preferably connected to or mounted to the cabinet of the gaming device. The embodiment shown in FIG. 6A includes a central display device 16 which displays a primary game. This display device may also display any secondary game associated with the primary game as well as information relating to the primary or secondary game. The alternative embodiment shown in FIG. 6B includes a central display device 16 and an upper display device 18. The upper display device may display the primary game, any suitable secondary game associated with the primary game and/or information relating to the primary or secondary game. In another embodiment, at least one display device may be a mobile display device, such as a PDA or tablet PC, that enables play of at least a portion of the primary or secondary game at a location remote from the gaming device. As seen in FIGS. 6A and 6B, in one embodiment, the gaming device includes a credit display 116 which displays a player's current number of credits, cash, account balance or the equivalent. In one embodiment, gaming device includes a total bet meter/bet display 122 which displays a player's amount wagered.

The display devices may include, without limitation, a monitor, a television display, a plasma display, a liquid crystal display (LCD) a display based on light emitting diodes (LED), a display based on a plurality of organic light-emitting diodes (OLEDs), a display based on polymer light-emitting diodes (PLEDs), a display including a projected and/or reflected image or any other suitable electronic device or display mechanism. In one embodiment, as described in more detail below, the display device includes a touch-screen with an associated touch-screen controller. The display devices may be of any suitable configuration, such as a square, a rectangle or an elongated rectangle.

The display devices of the gaming device are configured to display at least one and preferably a plurality of game or other suitable images, symbols and indicia such as any visual representation or exhibition of the movement of objects such as mechanical, virtual or video reels and wheels, dynamic lighting, video images, images of people, characters, places, things and faces of cards, tournament advertisements and the like.

In one alternative embodiment, the symbols, images and indicia displayed on or of the display device may be in mechanical form. That is, the display device may include any electromechanical device, such as one or more mechanical objects, such as one or more rotatable wheels, reels or dice, configured to display at least one and preferably a plurality of game or other suitable images, symbols or indicia.

As illustrated in FIG. 7A, in one embodiment, the gaming device includes at least one payment acceptor 24 in communication with the processor. As seen in FIGS. 6A and 6B, the payment acceptor may include a coin slot 26 and a payment, note or bill acceptor 28, where the player inserts money, coins or tokens. The player can place coins in the coin slot or paper money, ticket or voucher into the payment, note or bill acceptor. In other embodiments, devices such as readers or validators for credit cards, debit cards or credit slips may accept payment. In one embodiment, a player may insert an identification card into a card reader of the gaming device. In one embodiment, the identification card is a smart card having a programmed microchip or a magnetic strip coded with a player's identification, credit totals and other relevant information. In one embodiment, money may be transferred to a gaming device through electronic funds transfer. When a player funds the gaming device, the processor determines the amount of funds entered and displays the corresponding amount on the credit or other suitable display as described above.

As seen in FIGS. 6A, 6B and 7A, in one embodiment the gaming device includes at least one and preferably a plurality of input devices 30 in communication with the processor. The input devices can include any suitable device which enables the player to produce an input signal which is read by the processor. In one embodiment, after appropriate funding of the gaming device, the input device is a game activation device, such as a pull arm 32 or a play button 34 which is used by the player to start any primary game or sequence of events in the gaming device. The play button can be any suitable play activator such as a bet one button, a max bet button or a repeat the bet button. In one embodiment, upon appropriate funding, the gaming device begins the game play automatically. In another embodiment, upon the player engaging one of the play buttons, the gaming device automatically activates game play.

In one embodiment, as shown in FIGS. 6A and 6B, one input device is a bet one button 36. The player places a bet by pushing the bet one button. The player can increase the bet by one credit each time the player pushes the bet one button. When the player pushes the bet one button, the number of credits shown in the credit display preferably decreases by one, and the number of credits shown in the bet display preferably increases by one. In another embodiment, one input device is a bet max button (not shown) which enables the player to bet the maximum wager permitted for a game of the gaming device.

In one embodiment, one input device is a cash out button 38. The player may push the cash out button and cash out to receive a cash payment or other suitable form of payment corresponding to the number of remaining credits. In one embodiment, when the player cashes out, the player receives the coins or tokens in a coin payout tray 40. In one embodiment, when the player cashes out, the player may receive other payout mechanisms such as tickets or credit slips redeemable by a cashier or funding to the player's electronically recordable identification card.

In one embodiment, as mentioned above and seen in FIG. 7A, one input device is a touch-screen 42 coupled with a touch-screen controller 44, or some other touch-sensitive display overlay to allow for player interaction with the images on the display. The touch-screen and the touch-screen controller are connected to a video controller 46. A player can make decisions and input signals into the gaming device by touching the touch-screen at the appropriate places.

The gaming device may further include a plurality of communication ports for enabling communication of the processor with external peripherals, such as external video sources, expansion buses, game or other displays, an SCSI port or a key pad.

In one embodiment, as seen in FIG. 7A, the gaming device includes a sound generating device controlled by one or more sounds cards 48 which function in conjunction with the processor. In one embodiment, the sound generating device includes at least one and preferably a plurality of speakers 50 or other sound generating hardware and/or software for generating sounds, such as playing music for the primary and/or secondary game or for other modes of the gaming device, such as an attract mode. In one embodiment, the gaming device provides dynamic sounds coupled with attractive multimedia images displayed on one or more of the display devices to provide an audio-visual representation or to otherwise display full-motion video with sound to attract players to the gaming device. During idle periods, the gaming device may display a sequence of audio and/or visual attraction messages to attract potential players to the gaming device. The videos may also be customized for or to provide any appropriate information.

In one embodiment, the gaming machine may include a sensor, such as a camera in communication with the processor (and possibly controlled by the processor) that is selectively positioned to acquire an image of a player actively using the gaming device and/or the surrounding area of the gaming device. In one embodiment, the camera may be configured to selectively acquire still or moving (e.g., video) images and may be configured to acquire the images in either an analog, digital or other suitable format. The display devices may be configured to display the image acquired by the camera as well as display the visible manifestation of the game in split screen or picture-in-picture fashion. For example, the camera may acquire an image of the player and the processor may incorporate that image into the primary and/or secondary game as a game image, symbol or indicia.

Gaming device 10 can incorporate any suitable wagering primary or base game. The gaming machine or device may include some or all of the features of conventional gaming machines or devices. The primary or base game may comprise any suitable reel-type game, card game, number game or other game of chance susceptible to representation in an electronic or electromechanical form which produces a random outcome based on probability data upon activation from a wager. That is, different primary wagering games, such as video poker games, video blackjack games, video Keno, video bingo or any other suitable primary or base game may be implemented.

In one embodiment, as illustrated in FIGS. 6A and 6B, a base or primary game may be a slot game with one or more paylines 52. The paylines may be horizontal, vertical, circular, diagonal, angled or any combination thereof. In this embodiment, the gaming device displays at least one and preferably a plurality of reels 156 to 164, such as three to five reels in either electromechanical form with mechanical rotating reels or video form with simulated reels and movement thereof. In one embodiment, an electromechanical slot machine includes a plurality of adjacent, rotatable wheels which may be combined and operably coupled with an electronic display of any suitable type. In another embodiment, if the reels are in video form, one or more of the display devices, as described above, display the plurality of simulated video reels. Each reel displays a plurality of indicia such as bells, hearts, fruits, numbers, letters, bars or other images which preferably correspond to a theme associated with the gaming device. In this embodiment, the gaming device awards prizes when the reels of the primary game stop spinning if specified types and/or configurations of indicia or symbols occur on an active payline or otherwise occur in a winning pattern, occur on the requisite number of adjacent reels and/or occur in a scatter pay arrangement.

In one embodiment, a base or primary game may be a poker game wherein the gaming device enables the player to play a conventional game of video poker and initially deals five cards all face up from a virtual deck of fifty-two card deck. Cards may be dealt as in a traditional game of cards or in the case of the gaming device, may also include that the cards are randomly selected from a predetermined number of cards. If the player wishes to draw, the player selects the cards to hold via one or more input device, such as pressing related hold buttons or via the touch screen. The player then presses the deal button and the unwanted or discarded cards are removed from the display and the gaming machine deals the replacement cards from the remaining cards in the deck. This results in a final five-card hand. The gaming device compares the final five-card hand to a payout table which utilizes conventional poker hand rankings to determine the winning hands. The gaming device provides the player with an award based on a winning hand and the credits the player wagered.

In another embodiment, the base or primary game may be a multi-hand version of video poker. In this embodiment, the gaming device deals the player at least two hands of cards. In one such embodiment, the cards are the same cards. In one embodiment each hand of cards is associated with its own deck of cards. The player chooses the cards to hold in a primary hand. The held cards in the primary hand are also held in the other hands of cards. The remaining non-held cards are removed from each hand displayed and for each hand replacement cards are randomly dealt into that hand. Since the replacement cards are randomly dealt independently for each hand, the replacement cards for each hand will usually be different. The poker hand rankings are then determined hand by hand and awards are provided to the player.

In one embodiment, a base or primary game may be a keno game wherein the gaming device displays a plurality of selectable indicia or numbers on at least one of the display devices. In this embodiment, the player selects at least one and preferable a plurality of the selectable indicia or numbers via an input device or via the touch screen. The gaming device then displays a series of drawn numbers to determine an amount of matches, if any, between the player's selected numbers and the gaming device's drawn numbers. The player is provided an award based on the amount of matches, if any, based on the amount of determined matches.

In one embodiment, in addition to winning credits in a base or primary game, the gaming device may also give players the opportunity to win credits in a bonus or secondary game or bonus or secondary round. The bonus or secondary game enables the player to obtain a prize or payout in addition to the prize or payout, if any, obtained from the base or primary game. In general, a bonus or secondary game produces a significantly higher level of player excitement than the base or primary game because it provides a greater expectation of winning than the base or primary game and is accompanied with more attractive or unusual features than the base or primary game.

In one embodiment, the bonus or secondary game may be any type of suitable game, either similar to or completely different from the base or primary game. In one embodiment, the gaming device includes a program which will automatically begin a bonus round when the player has achieved a triggering event or qualifying condition in the base or primary game. In one embodiment, the triggering event or qualifying condition may be a selected outcome in the primary game or a particular arrangement of one or more indicia on a display device in the primary game, such as the number seven appearing on three adjacent reels along a payline in the primary slot game embodiment seen in FIGS. 6A and 6B. In another embodiment, the triggering event or qualifying condition may be by exceeding a certain amount of game play (number of games, number of credits, amount of time), reaching a specified number of points earned during game play or as a random award.

In one embodiment, once a player has qualified for a bonus game, the player may subsequently enhance his/her bonus game participation through continued play on the base or primary game. Thus, for each bonus qualifying event, such as a bonus symbol, that the player obtains, a given number of bonus game wagering points or credits may be accumulated in a “bonus meter” programmed to accrue the bonus wagering credits or entries toward eventual participation in a bonus game. The occurrence of multiple such bonus qualifying events in the primary game may result in an arithmetic or geometric increase in the number of bonus wagering credits awarded. In one embodiment, the player may redeem extra bonus wagering credits during the bonus game to extend play of the bonus game.

In one embodiment, no separate entry fee or buy in for a bonus game need be employed. That is, a player may not purchase an entry into a bonus game, rather they must win or earn entry through play of the primary game thus, encouraging play of the primary game. In another embodiment, qualification of the bonus or secondary game could be accomplished through a simple “buy in” by the player if, for example, the player has been unsuccessful at qualifying through other specified activities.

In one embodiment, as illustrated in FIG. 7B, one or more of the gaming devices 10 may be connected to each other through a data network or a remote communication link 58 with some or all of the functions of each gaming device provided at a central location such as a central server or central controller 56. More specifically, the processor of each gaming device may be designed to facilitate transmission of signals between the individual gaming device and the central server or controller.

In one embodiment, the game outcome provided to the player is determined by a central server or controller and provided to the player at the gaming device. In this embodiment, each of a plurality of such gaming devices are in communication with the central server or controller. Upon a player initiating game play at one of the gaming devices, the initiated gaming device communicates a game outcome request to the central server or controller.

In one embodiment, the central server or controller receives the game outcome request and randomly generates a game outcome for the primary game based on probability data. In another embodiment, the central server or controller randomly generates a game outcome for the secondary game based on probability data. In another embodiment, the central server or controller randomly generates a game outcome for both the primary game and the secondary game based on probability data. In this embodiment, the central server or controller is capable of storing and utilizing program code or other data similar to the processor and memory device of the gaming device.

In an alternative embodiment, the central server or controller maintains one or more predetermined pools or sets of predetermined game outcomes. In this embodiment, the central server or controller receives the game outcome request and independently selects a predetermined game outcome from a set or pool of game outcomes. The central server or controller flags or marks the selected game outcome as used. Once a game outcome is flagged as used, it is prevented from further selection from the set or pool and cannot be selected by the central controller or server upon another wager. The provided game outcome can include a primary game outcome, a secondary game outcome, primary and secondary game outcomes, or a series of game outcomes such a free games.

The central server or controller communicates the generated or selected game outcome to the initiated gaming device. The gaming device receives the generated or selected game outcome and provides the game outcome to the player. In an alternative embodiment, how the generated or selected game outcome is to be presented or displayed to the player, such as a reel symbol combination of a slot machine or a hand of cards dealt in a card game, is also determined by the central server or controller and communicated to the initiated gaming device to be presented or displayed to the player. Central production or control can assist a gaming establishment or other entity in maintaining appropriate records, controlling gaming, reducing and preventing cheating or electronic or other errors, reducing or eliminating win-loss volatility and the like.

In another embodiment, a predetermined game outcome value is determined for each of a plurality of linked or networked gaming devices based on the results of a bingo or keno game. In this embodiment, each individual gaming device utilizes one or more bingo or keno games to determine the predetermined game outcome value provided to the player for the interactive game played at that gaming device. In one embodiment, the bingo or keno game is displayed to the player. In another embodiment, the bingo or keno game is not displayed to the player, but the results of the bingo or keno game determine the predetermined game outcome value for the interactive game.

In the various bingo embodiments, as each gaming device is enrolled in the bingo game, such as upon an appropriate wager or engaging an input device, the enrolled gaming device is provided or associated with a different bingo card. Each bingo card consists of a matrix or array of elements, wherein each element is designated with a separate indicia, such as a number. It should be appreciated that each different bingo card includes a different combination of elements. For example, if four bingo cards are provided to four enrolled gaming devices, the same element may be present on all four of the bingo cards while another element may solely be present on one of the bingo cards.

In operation of these embodiments, upon providing or associating a different bingo card to each of a plurality of enrolled gaming devices, the central controller randomly selects or draws, one at a time, a plurality of the elements. As each element is selected, a determination is made for each gaming device as to whether the selected element is present on the bingo card provided to that enrolled gaming device. This determination can be made by the central controller, the gaming device, a combination of the two, or in any other suitable manner. If the selected element is present on the bingo card provided to that enrolled gaming device, that selected element on the provided bingo card is marked or flagged. This process of selecting elements and marking any selected elements on the provided bingo cards continues until one or more predetermined patterns are marked on one or more of the provided bingo cards. It should be appreciated that in one embodiment, the gaming device requires the player to engage a “daub” button (not shown) to initiate the process of the gaming device marking or flagging any selected elements.

After one or more predetermined patterns are marked on one or more of the provided bingo cards, a game outcome is determined for each of the enrolled gaming devices based, at least in part, on the selected elements on the provided bingo cards. As described above, the game outcome determined for each gaming device enrolled in the bingo game is utilized by that gaming device to determine the predetermined game outcome provided to the player. For example, a first gaming device to have selected elements marked in a predetermined pattern is provided a first outcome of win $10 which will be provided to a first player regardless of how the first player plays in a first game and a second gaming device to have selected elements marked in a different predetermined pattern is provided a second outcome of win $2 which will be provided to a second player regardless of how the second player plays a second game. It should be appreciated that as the process of marking selected elements continues until one or more predetermined patterns are marked, this embodiment insures that at least one bingo card will win the bingo game and thus at least one enrolled gaming device will provide a predetermined winning game outcome to a player. It should be appreciated that other suitable methods for selecting or determining one or more predetermined game outcomes may be employed.

In one example of the above-described embodiment, the predetermined game outcome may be based on a supplemental award in addition to any award provided for winning the bingo game as described above. In this embodiment, if one or more elements are marked in supplemental patterns within a designated number of drawn elements, a supplemental or intermittent award or value associated with the marked supplemental pattern is provided to the player as part of the predetermined game outcome. For example, if the four corners of a bingo card are marked within the first twenty selected elements, a supplemental award of $10 is provided to the player as part of the predetermined game outcome. It should be appreciated that in this embodiment, the player of a gaming device may be provided a supplemental or intermittent award regardless of if the enrolled gaming device's provided bingo card wins or does not win the bingo game as described above.

In another embodiment, one or more of the gaming devices are in communication with a central server or controller for monitoring purposes only. That is, each individual gaming device randomly generates the game outcomes to be provided to the player and the central server or controller monitors the activities and events occurring on the plurality of gaming devices. In one embodiment, the gaming network includes a real-time or on-line accounting and gaming information system operably coupled to the central server or controller. The accounting and gaming information system of this embodiment includes a player database for storing player profiles, a player tracking module for tracking players and a credit system for providing automated casino transactions.

A plurality of the gaming devices are capable of being connected together through a data network. In one embodiment, the data network is a local area network (LAN), in which one or more of the gaming devices are substantially proximate to each other and an on-site central server or controller as in, for example, a gaming establishment or a portion of a gaming establishment. In another embodiment, the data network is a wide area network (WAN) in which one or more of the gaming devices are in communication with at least one off-site central server or controller. In this embodiment, the plurality of gaming devices may be located in a different part of the gaming establishment or within a different gaming establishment than the off-site central server or controller. Thus, the WAN may include an off-site central server or controller and an off-site gaming device located within gaming establishments in the same geographic area, such as a city or state. The WAN gaming system may be substantially identical to the LAN gaming system described above, although the number of gaming devices in each system may vary relative to each other.

In another embodiment, the data network is an internet or intranet. In this embodiment, the operation of the gaming device can be viewed at the gaming device with at least one internet browser. In this embodiment, operation of the gaming device and accumulation of credits may be accomplished with only a connection to the central server or controller (the internet/intranet server) through a conventional phone or other data transmission line, digital subscriber line (DSL), T-1 line, coaxial cable, fiber optic cable, or other suitable connection. In this embodiment, players may access an internet game page from any location where an internet connection and computer, or other internet facilitator are available. The expansion in the number of computers and number and speed of internet connections in recent years increases opportunities for players to play from an ever-increasing number of remote sites. It should be appreciated that enhanced bandwidth of digital wireless communications may render such technology suitable for some or all communications, particularly if such communications are encrypted. Higher data transmission speeds may be useful for enhancing the sophistication and response of the display and interaction with the player.

In another embodiment, as described above, one or more gaming devices are in communication with a central server or controller. The central server or controller may be any suitable server or computing device which includes at least one processor and a memory or storage device. In alternative embodiments, the central server is a progressive controller or another gaming machine in the gaming system. In one embodiment, the memory device stores different game programs and instructions, executable by a gaming device processor, to control the gaming device. Each executable game program represents a different game or type of game which may be played on one or more of the gaming devices in the gaming system. Such different games may include the same or substantially the same game play with different pay tables. In different embodiments, the executable game program is for a primary game, a secondary game or both. In another embodiment, the game program may be executable as a secondary game to be played simultaneous with the play of a primary game (which may be downloaded to or fixed on the gaming device) or vice versa.

In this embodiment, each gaming device at least includes one or more display devices and/or one or more input devices for interaction with a player. A local processor, such as the above-described gaming device processor or a processor of a local server, is operable with the display device(s) and/or the input device(s) of one or more of the gaming devices.

In operation, the central controller is operable to communicate one or more of the stored game programs to at least one local processor. In different embodiments, the stored game programs are communicated or delivered by embedding the communicated game program in a device or a component (e.g., a “chip” to be inserted in a gaming device), writing the game program on a disc or other media, downloading or streaming the game program over a dedicated data network, internet or a telephone line. After the stored game programs are communicated from the central server, the local processor executes the communicated program to facilitate play of the communicated program by a player through the display device(s) and/or input device(s) of the gaming device. That is, when a game program is communicated to a local processor, the local processor changes the game or type of game played at the gaming device.

In another embodiment, a plurality of gaming devices at one or more gaming sites may be networked to a central server in a progressive configuration, as known in the art, wherein a portion of each wager to initiate a base or primary game may be allocated to bonus or secondary event awards. In one embodiment, a host site computer is coupled to a plurality of the central servers at a variety of mutually remote gaming sites for providing a multi-site linked progressive automated gaming system. In one embodiment, a host site computer may serve gaming devices distributed throughout a number of properties at different geographical locations including, for example, different locations within a city or different cities within a state.

In one embodiment, the host site computer is maintained for the overall operation and control of the system. In this embodiment, a host site computer oversees the entire progressive gaming system and is the master for computing all progressive jackpots. All participating gaming sites report to, and receive information from, the host site computer. Each central server computer is responsible for all data, communication between the gaming device hardware and software and the host site computer. In one embodiment, an individual gaming machine may trigger a progressive win, for example through a game play event such as a symbol-driven trigger. In one embodiment, the central server or other central controller determines when a progressive win is triggered. In one embodiment, a central controller and an individual gaming machine work in conjunction with each other to determine when a progressive win is triggered, for example through an individual gaming machine meeting a predetermined requirement established by the central controller.

While the present invention is described in connection with what is presently considered to be the most practical and preferred embodiments, it should be appreciated that the invention is not limited to the disclosed embodiments, and is intended to cover various modifications and equivalent arrangements included within the spirit and scope of the claims. Modifications and variations in the present invention may be made without departing from the novel aspects of the invention as defined in the claims, and this application is limited only by the scope of the claims.

The invention is claimed as follows:

1. A gaming device operable under control of a processor, said gaming device comprising:
a game controlled by the processor;
a plurality of symbols in the game, said plurality of symbols including at least one predetermined symbol;
a plurality of symbol positions in the game;
a plurality of paylines in the game;
a plurality of values associated with a plurality of winning symbol combinations; and
a display device operable to display said game;
wherein said processor is operable with the display device to control a play of the game by:
(a) enabling a player to participate in the game by placing a wager on at least one of the paylines, wherein each of the wagers placed on the paylines form a total wager;
(b) generating a plurality of the symbols at the symbol positions;
(c) determining if at least one winning symbol combination is generated;
(d) determining if the predetermined symbol is generated; and
(e) if at least one winning symbol combination is generated and the predetermined symbol is generated:
(i) determining the most valuable winning symbol combination appearing on any of the paylines;
(ii) determining a modified value by multiplying the value associated with the determined most valuable winning symbol combination by the total wager placed to participate in the play of the game, and
(iii) providing the determined modified value to the player.

2. The gaming device of claim 1, wherein if at least one winning symbol combination is generated and the predetermined symbol is not generated, the processor is operable to control the play of the game by providing the player the value associated with the generated winning symbol combination.

3. A method of operating a gaming device, said method comprising:
(a) enabling a player to participate in a play of a game by placing a wager on at least one of a plurality of paylines, wherein each of the wagers placed on the paylines form a total wager;
(b) generating a plurality of symbols at a plurality of symbol positions;
(c) determining if at least one winning symbol combination is generated;
(d) determining if at least one predetermined symbol is generated; and
(e) if at least one winning symbol combination is generated and at least one predetermined symbol is generated:
(i) determining the most valuable winning symbol combination appearing on any of the paylines;
(ii) determining a modified value by multiplying a value associated with the determined most valuable winning symbol combination by the total wager placed to participate in the play of the game, and
(iii) providing the determined modified value to the player.

4. The method of claim 3, which includes providing the player the value associated with the generated winning symbol combination if at least one winning symbol combination is generated and the predetermined symbol is not generated.

5. The method of claim 3, which is provided through a data network.

6. The method of claim 5, wherein the data network is an internet.
